(19) United States
(12) Patent Application Publication
(10) Pub. No.: US 2026/0141594 A1
(43) Pub. Date: May 21, 2026

(54) CONTROLLABLE IMAGE SYNTHESIS FOR TRANSFORMER-BASED IMAGE GENERATION MODELS

(71) Applicant: ADOBE INC., SAN JOSE, CA (US)

(72) Inventors: Tristan von Busch, Drochtersen (DE); Tobias Hinz, Campbell, CA (US)

(21) Appl. No.: 18/955,806

(22) Filed: Nov. 21, 2024

(51) Int. Cl. G06T 11/60

(52) U.S. Cl. CPC G06T 11/60

(57) ABSTRACT

A method, apparatus, non-transitory computer readable medium, and system for image processing include obtaining a condition map comprising a spatial representation of a target image structure, encoding the condition map to obtain a condition sequence of tokens representing the target image structure, generating an output sequence of tokens based on the condition sequence of tokens and a preliminary sequence of tokens from a discrete codebook, and generating a synthetic image based on the output sequence of tokens, where the synthetic image depicts a scene with the target image structure.

### BACKGROUND

The following relates generally to image processing, and more specifically to image generation using a machine learning model. Image processing refers to the use of a computer to edit an image using an algorithm or a processing network. In some cases, image processing software can be used for various image processing tasks, such as image restoration, image detection, image editing, image compositing, and image generation. For example, image generation includes the use of a machine learning model to generate a synthetic image based on an input such as a text prompt, an image, or a style.

In the field of image generation, a condition map is provided to a machine learning model to generate a synthetic image. In some cases, the synthetic image depicts one or more elements represented by the condition. For example, the condition map may be an edge map depicting a target structure of the synthetic image to be generated. However, in some cases, conventional systems are unable to generate synthetic images that adhere to the target structure represented in the condition map.

### SUMMARY

A method, apparatus, non-transitory computer readable medium, and system for image processing include obtaining a condition map comprising a spatial representation of a target image structure, encoding, using a condition encoder of an image generation model, the condition map to obtain a condition sequence of tokens representing the target image structure, where a token of the condition sequence of tokens comprises an index corresponding to an image patch location, generating, using a transformer of the image generation model, an output sequence of tokens based on the condition sequence of tokens and a preliminary sequence of tokens from a discrete codebook, where a token of the output sequence of tokens comprises a token from the discrete codebook with the index indicating the image patch location, and generating, using a decoder the image generation model, a synthetic image based on the output sequence of tokens, where the synthetic image depicts a scene with the target image structure.

A method, apparatus, non-transitory computer readable medium, and system for image processing include encoding, using a first linear attention process, a condition map to obtain a condition sequence of tokens representing a target image structure, generating an output sequence of tokens based on the condition sequence of tokens and a preliminary sequence of tokens, and generating a synthetic image based on the output sequence of tokens, where the synthetic image depicts a scene with the target image structure.

An apparatus and system for image processing include a memory component, a processing device coupled to the memory component, the processing device configured to perform operations comprising: obtaining a condition map comprising a spatial representation of a target image structure, encoding, using a condition encoder of an image generation model, the condition map to obtain a condition sequence of tokens representing the target image structure, where a token of the condition sequence of tokens comprises an index corresponding to an image patch location, generating, using a transformer of the image generation model, an output sequence of tokens based on the condition sequence of tokens and a preliminary sequence of tokens from a discrete codebook, where a token of the output sequence of tokens comprises a token from the discrete codebook with the index indicating the image patch location, and generating, using a decoder the image generation model, a synthetic image based on the output sequence of tokens, where the synthetic image depicts a scene with the target image structure.

### BRIEF DESCRIPTION OF THE DRAWINGS

FIG. 1 shows an example of an image processing system according to aspects of the present disclosure.

FIG. 2 shows an example of a method for conditional image generation according to aspects of the present disclosure.

FIG. 3 shows an example of image generation based on an edge map according to aspects of the present disclosure.

FIG. 4 shows an example of image generation based on a spatial color map according to aspects of the present disclosure.

FIG. 5 shows an example of image generation based on a depth map according to aspects of the present disclosure.

FIG. 6 shows an example of a method for image generation based on a condition map according to aspects of the present disclosure.

FIG. 7 shows an example of an image processing apparatus according to aspects of the present disclosure.

FIG. 8 shows an example of a machine learning model according to aspects of the present disclosure.

FIG. 9 shows an example of data flow in a machine learning model according to aspects of the present disclosure.

FIG. 10 shows an example of a flow diagram depicting an algorithm as a step-by-step procedure in an example implementation of operations performable for training a machine learning model according to aspects of the present disclosure.

FIG. 11 shows an example of a computing device according to aspects of the present disclosure.

### DETAILED DESCRIPTION

The following relates to image generation using generative machine learning. Embodiments of the disclosure relate to an image generation system that accurately generates a synthetic image based on an input condition map depicting a target image structure. In one aspect, the system includes a condition encoder trained to generate a condition sequence of tokens in a discrete latent space based on the input condition map. The system further includes a transformer configured to generate an intermediate output sequence of tokens in the discrete latent space based on an input (e.g., a masked image, an input image, or a mask token). By combining the condition sequence of tokens and the intermediate output sequence of tokens to generate an output sequence of tokens, the system can accurately generate image content that aligns with the target image structure depicted in the input condition map.

According to some embodiments, the system includes a transformer network configured to generate a synthetic image based on an input image or a masked token image. In some aspects, the system includes a condition transformer network (e.g., a duplicate network of the transformer network) trained to generate a condition sequence of tokens in the discrete latent space based on an input condition map. For example, the condition transformer network includes a condition encoder trained to generate a condition embedding based on the condition map. In some cases, the condition embedding may be a condition sequence of tokens in a discrete latent space. The condition transformer network includes a duplicate transformer trained to generate a condition intermediate output based on the condition sequence of tokens.

According to some embodiments, the transformer network includes an image encoder configured to generate a preliminary sequence of tokens based on an input (e.g., an input image or a masked token image). The transformer network further includes a transformer configured to generate an intermediate output based on the preliminary sequence of tokens. In some embodiments, the intermediate output and the condition intermediate output are combined to generate combined output. In some embodiments, the system includes a decoder (e.g., an image decoder) configured to decode the combined output to generate the synthetic image having an image structure that aligns with the target image structure depicted in the condition map.

A subfield in image processing relates to image generation based on a condition map. A conventional image generation system (such as Masked Generative Image Transformer “MaskGIT”) takes a masked token image as input and generates synthetic images. During the image generation process, the model iteratively refines the image by predicting and updating masked tokens in parallel. In some cases, the system uses a bidirectional transformer that allows simultaneous, iterative prediction across the image. However, the system is unable to accurately generate images having complex image structures like human faces. In some cases, the system is unable to take an input condition map depicting a target image structure and generate a synthetic image depicting image elements and having a structure that aligns with the target image structure.

Some conventional systems use a combination of a ControlNet and an image generation model (e.g., a diffusion-based generative model) to generate a synthetic image based on a condition map. For example, these systems take structured input conditions (such as edge maps or depth maps) and generate synthetic images that adhere to these structures depicted in the input conditions. During the image generation process, ControlNet supplies structural cues that guide the Diffusion Model in progressively refining the output to match the target image structure. In some cases, the composition and content of generated images can be controlled by the input conditions. However, these systems are sensitive to the quality of input conditions, often struggling with ambiguous or incomplete cues. In some cases, due to the iterative nature of diffusion, the systems require significant computational resources, which increase the inference time, and thus limit the applicability in real-time settings. In some cases, these systems may fail to generalize accurately when input conditions are unusual or deviate from the training data, resulting in less realistic image details.

Embodiments of the disclosure improve on conventional image generation models by generating a synthetic image more accurately based on a condition map. This is achieved using a system that includes a duplicate transformer network trained to generate a condition intermediate output based on the input condition map, and a transformer network configured to generate an intermediate output based on a masked token image (e.g., from a system input). By combining the condition intermediate output and the intermediate output to generate a combined output, the image generation system is able to generate a synthetic image including an image structure that aligns with the target image structure depicted in the condition map.

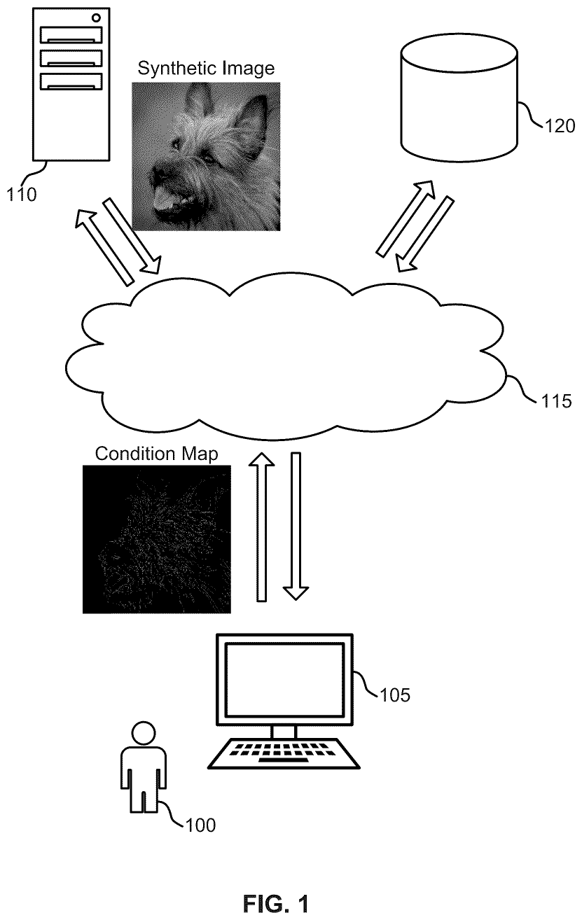

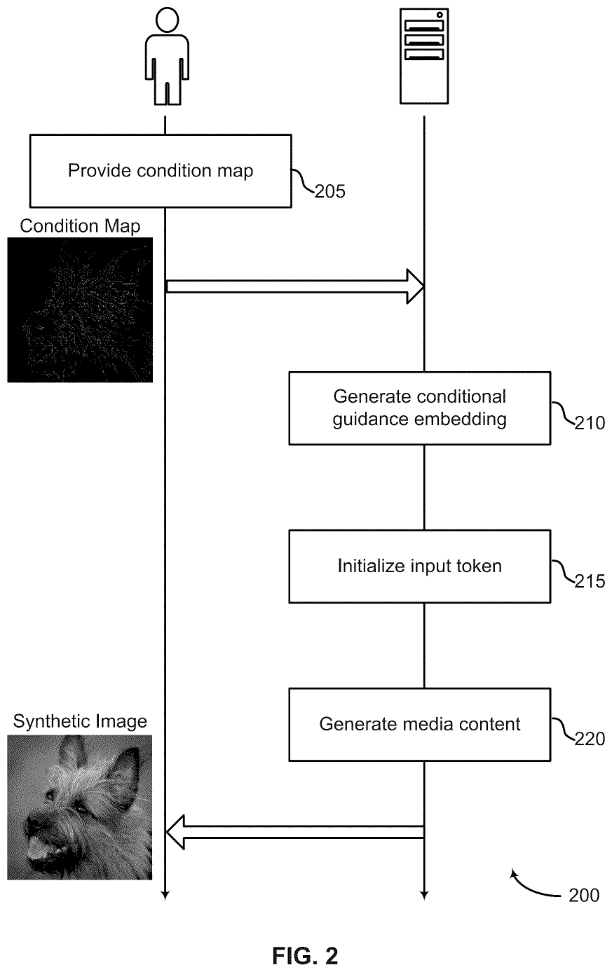

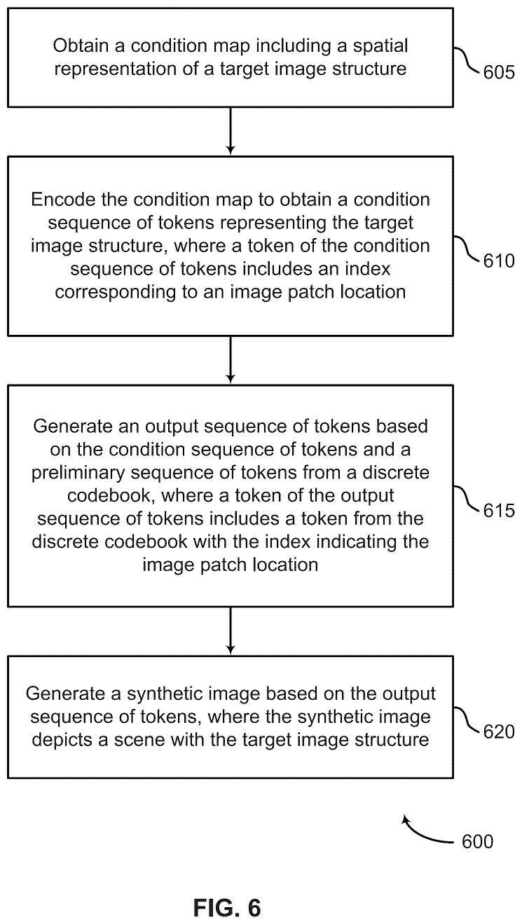

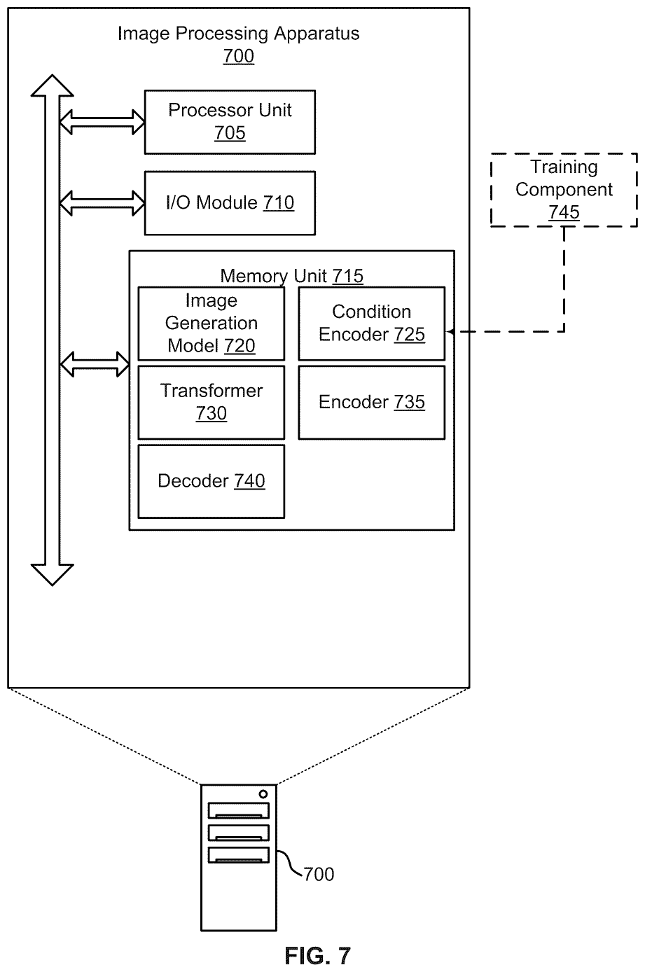

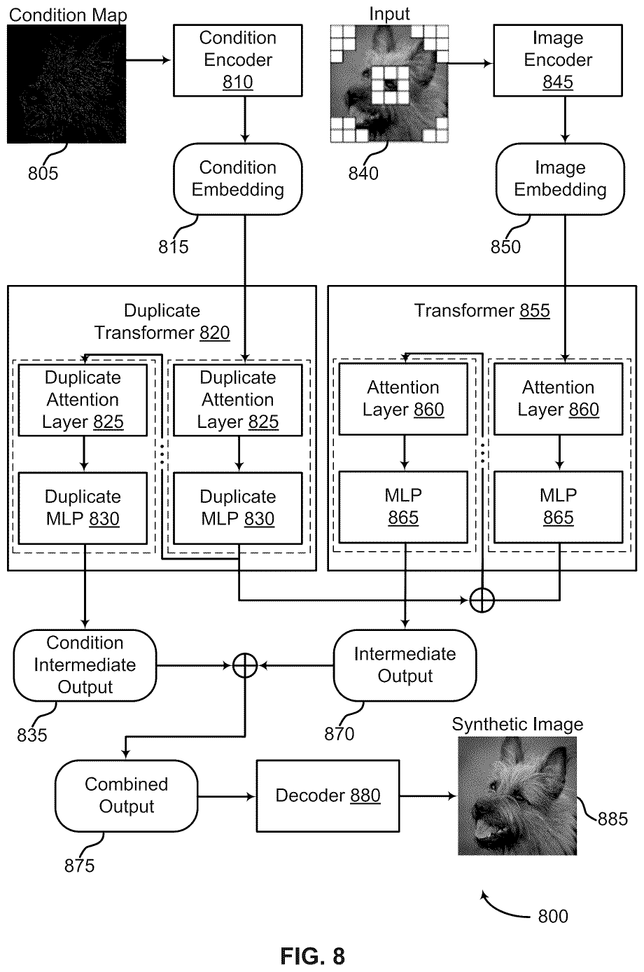

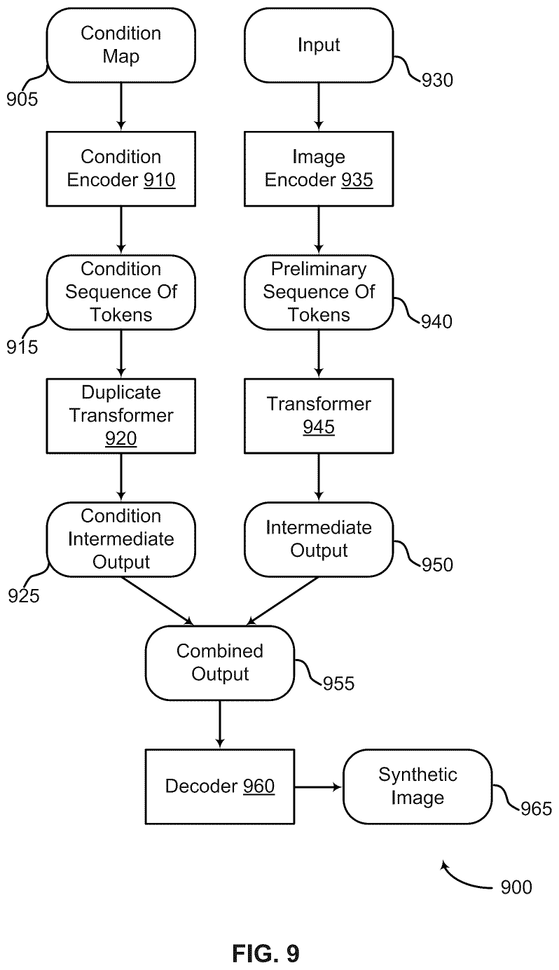

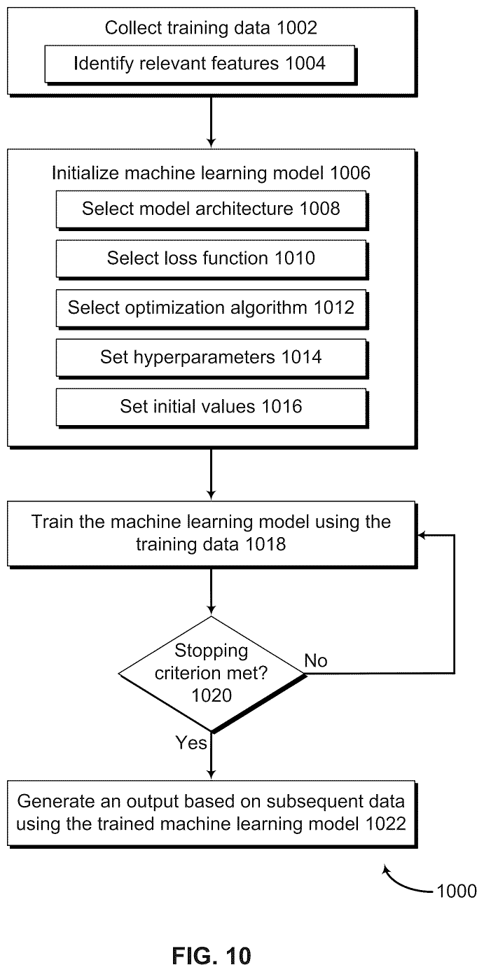

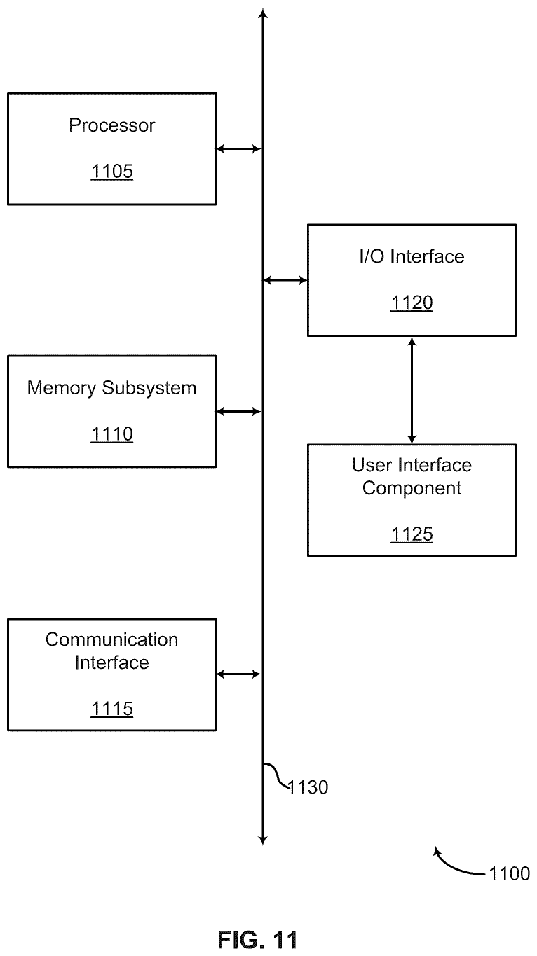

An example system of the present disclosure in image processing is provided with reference to FIGS. 1 and 11. An example application of the present disclosure in image processing is provided with reference to FIGS. 2-5. Details regarding the architecture of an image processing apparatus are provided with reference to FIGS. 7-8. An example of a process for image processing is provided with reference to FIGS. 6 and 9. A description of an example training process is provided with reference to FIG. 10.

Accordingly, the present disclosure provides a system and a method that improve on conventional image generation systems by accurately generating a synthetic image that aligns with a target image structure based on a condition map depicting the target image structure. By generating tokens based on the input condition map in a discrete latent space, the system is able to capture diverse patterns and avoid overfitting to specific details. In some aspects, using discrete tokens increases decoding speed (e.g., increases the overall system efficiency) and enables direct control over specific image features. In some aspects, the discrete latent space reduces mode collapse (e.g., separation of modes such as color, object, or shape based on the categorical class), and thus enables the system to generate a wider variety of outputs. In some aspects, discrete tokens require less memory and computation, and thus reduce processing speed and increase efficiency in a computing device.

### Image Generation

In FIGS. 1-6 and 9, a method, apparatus, non-transitory computer readable medium, and system for image processing include obtaining a condition map comprising a spatial representation of a target image structure, encoding, using a condition encoder of an image generation model, the condition map to obtain a condition sequence of tokens representing the target image structure, where a token of the condition sequence of tokens comprises an index corresponding to an image patch location, generating, using a transformer of the image generation model, an output sequence of tokens based on the condition sequence of tokens and a preliminary sequence of tokens from a discrete codebook, where a token of the output sequence of tokens comprises a token from the discrete codebook with the index indicating the image patch location, and generating, using a decoder the image generation model, a synthetic image based on the output sequence of tokens, where the synthetic image depicts a scene with the target image structure.

Some examples of the method, apparatus, non-transitory computer readable medium, and system further include performing a linear attention process on the condition sequence of tokens to obtain a subsequent condition sequence of tokens. In some cases, the output sequence of tokens is generated based on the subsequent condition sequence of tokens. In some aspects, each of the preliminary sequence of tokens comprises a mask token.

Some examples of the method, apparatus, non-transitory computer readable medium, and system further include performing a linear attention process on the preliminary sequence of tokens. In some aspects, the linear attention process comprises an autoregressive generation process. In some aspects, the linear attention process comprises a bidirectional generation process.

Some examples of the method, apparatus, non-transitory computer readable medium, and system further include combining the condition sequence of tokens and the preliminary sequence of tokens to obtain a combined sequence of tokens, where the output sequence of tokens is based on the combined sequence of tokens. In some aspects, the condition map comprises an edge map, a spatial color map, or a depth map.

In some embodiments, a method, apparatus, non-transitory computer readable medium, and system for image processing include encoding, using a first linear attention process, a condition map to obtain a condition sequence of tokens representing a target image structure; generating, using a second linear attention process, an output sequence of tokens based on the condition sequence of tokens and a preliminary sequence of tokens; and generating, using an image generation model, a synthetic image based on the output sequence of tokens, where the synthetic image depicts a scene with the target image structure.

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIG. 7.

Referring to FIG. 1, user 100 provides a condition map to image processing apparatus 110 via user device 105 through cloud 115 to generate a synthetic image. In some cases, the condition map includes a spatial representation of a target image structure to be generated in the synthetic image. For example, the condition map includes an edge map depicting the edges of an image element to be generated in the synthetic image. In some aspects, the image processing apparatus 110 includes a machine learning model that processes the input and generates the output. For example, the machine learning model includes a duplicate transformer network trained to generate a condition intermediate output based on the condition map. For example, the machine learning model includes a transformer network configured to take a masked token image to generate an intermediate output. In some cases, the condition intermediate output and the intermediate output are combined at each transformer block/layer to generate a combined intermediate output. In some aspects, the machine learning model includes a decoder configured to decode the combined intermediate output to generate the synthetic image. In some cases, the synthetic image depicts an image element (e.g., a dog) having the same image structure depicted in the input image.

User device 105 may be a personal computer, laptop computer, mainframe computer, palmtop computer, personal assistant, mobile device, or any other suitable processing apparatus. In some examples, user device 105 includes software that incorporates an image processing application. In some examples, the image processing application on user device 105 may include functions of image processing apparatus 110. In some cases, user device 105 may include a user interface that performs functions of the image processing apparatus 110.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the image processing apparatus 110 is further described with reference to FIG. 2.

Image processing apparatus 110 is an example of, or includes aspects of, the corresponding element described with reference to FIG. 8. According to some aspects, image processing apparatus 110 includes a computer implemented network comprising a machine learning model, an image generation model, a condition encoder, a transformer, an encoder, and a decoder. Image processing apparatus 110 further includes a processor unit, a memory unit, an I/O module, a user interface, and a training component. In some embodiments, image processing apparatus 110 further includes a communication interface, user interface components, and a bus as described with reference to FIG. 11. Additionally or alternatively, image processing apparatus 110 communicates with user device 105 and database 120 via cloud 115. Further detail regarding the operation of image processing apparatus 110 is described with reference to FIG. 2.

In some cases, image processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In some examples, cloud 115 is based on a local collection of switches in a single physical location.

According to some aspects, database 120 stores training data including an image and a text prompt describing the image. In some aspects, database 120 stores output generated from the image processing apparatus 110. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In other cases, the database controller may operate automatically without user interaction.

FIG. 2 shows an example of a method 200 for conditional image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 205, the system provides a condition map. In some cases, the operations of this step refer to, or may be performed by, a user as described with reference to FIG. 1. In some cases, for example, the condition map includes an edge map, a spatial color map, or a depth map. For example, the edge map depicts outlines or boundaries within an image or an image to be generated. In some cases, the edge map depicts locations where changes in intensity occur. In some cases, for example, the spatial color map represents colors patches corresponding to regions in an image or an image to be generated and indicates spatial distribution of color. In some cases, for example, the depth map represents the distance of object from a viewpoint (e.g., a camera), where the objects near the viewpoint are represented in a light color (e.g., white) and the object further from the viewpoint is represented in a dark color (e.g., black).

At operation 210, the system generates conditional guidance embedding. In some cases, the operations of this step refer to, or may be performed by, an image processing apparatus as described with reference to FIGS. 1 and 7. In some cases, the operations of this step refer to, or may be performed by, a condition encoder as described with reference to FIGS. 7-9. In some cases, a condition encoder receives the condition map and generates a condition sequence of tokens based on the condition map. For example, the condition sequence of tokens is in a discrete latent space. In some cases, the condition sequence of tokens may be represented as discrete visual tokens in a matrix or a vector. In some embodiments, a duplicate transformer takes the condition sequence of tokens and generates a condition intermediate output.

At operation 215, the system initializes input token. In some cases, the operations of this step refer to, or may be performed by, an image processing apparatus as described with reference to FIGS. 1 and 7. In some cases, the operations of this step refer to, or may be performed by, an image generation model as described with reference to FIG. 7. In some cases, an image encoder receives a masked token image to generate a preliminary sequence of tokens. For example, a transformer takes the preliminary sequence of tokens and generates intermediate output. In some embodiments, the intermediate output and the condition intermediate output are combined to generate combined intermediate output.

At operation 220, the system generates media content. In some cases, the operations of this step refer to, or may be performed by, an image processing apparatus as described with reference to FIGS. 1 and 7. In some cases, the operations of this step refer to, or may be performed by, an image generation model as described with reference to FIG. 7. In some cases, the decoder decodes the combined intermediate output and generate a synthetic image based on the combined intermediate output. In some cases, the synthetic image depicts one or more image elements and an image structure that aligns with the target image structure depicted in the condition map.

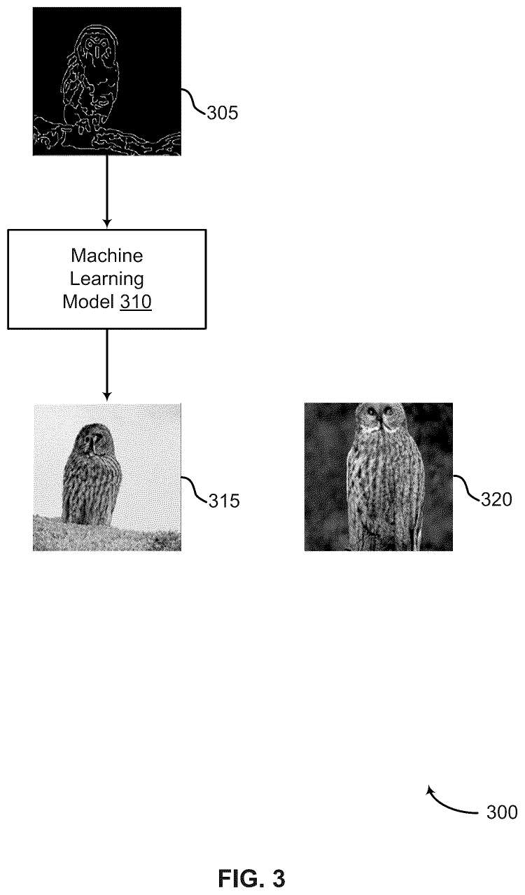

FIG. 3 shows an example of image generation based on an edge map 305 according to aspects of the present disclosure. The example shown includes image generation system 300, edge map 305, machine learning model 310, synthetic image 315, and conventional output image 320. In some embodiments, image generation system 300 is implemented in a user interface.

Referring to FIG. 3, the image generation system 300 receives a condition map and generates a synthetic image 315 based on the condition map. For example, the condition map includes an edge map 305. In some cases, the machine learning model 310 receives the edge map 305 and generates a condition sequence of tokens in the discrete latent space. Then, the condition sequence of tokens passes through a set of transformer blocks within a duplicate transformer of the machine learning model 310, where the duplicate transformer generates a condition intermediate output (e.g., a sequence of transformed tokens representing the condition map). In some cases, the machine learning model 310 takes an image mask (e.g., stored in the database) and generates a preliminary sequence of tokens representing the image mask in the discrete latent space. In some cases, the preliminary sequence of tokens passes through a set of transformer blocks within a transformer of the machine learning model 310, where the transformer generates an intermediate output (e.g., a sequence of transformed tokens representing the image mask).

In some embodiments, the condition intermediate output and the intermediate output are combined to generate combined intermediate output at each transformer block of the set of transformer blocks, and the combined intermediate output is used as input to the transformer block to generate the next intermediate output. After the last transformer block, the combined intermediate output is provided to a decoder to generate the synthetic image 315. In some cases, the synthetic image 315 includes the target image structure from the input condition. For example, the synthetic image 315 adheres to the target image structure while maintaining alignment with the class label associated with each image. For example, the edge map 305 depicts the boundaries (e.g., image structure) of an owl, and the synthetic image 315 depicts the owl having edges that are aligned with the same boundaries.

In some cases, a conventional image generation system (e.g., MaskGIT) is unable to accurately generate a conventional output image 320 depicting the same target image structure from the condition map. In some cases, the conventional system is not fine-tuned with the additional condition input (e.g., the edge map 305). In some cases, the conventional system generates an image by predicting masked tokens. However, the conventional system lacks the fine-grained adaptability that the condition map provides. Accordingly, by using the machine learning model 310 (which includes the condition encoder and the duplicate transformer) to generate the condition intermediate output based on the condition map, the machine learning model 310 is able to accurately generate a synthetic image 315 that aligns with the target image structure.

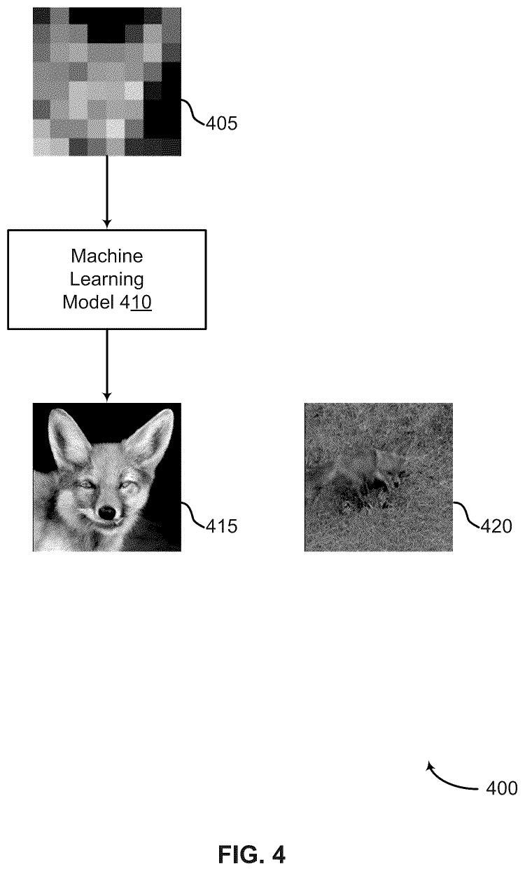

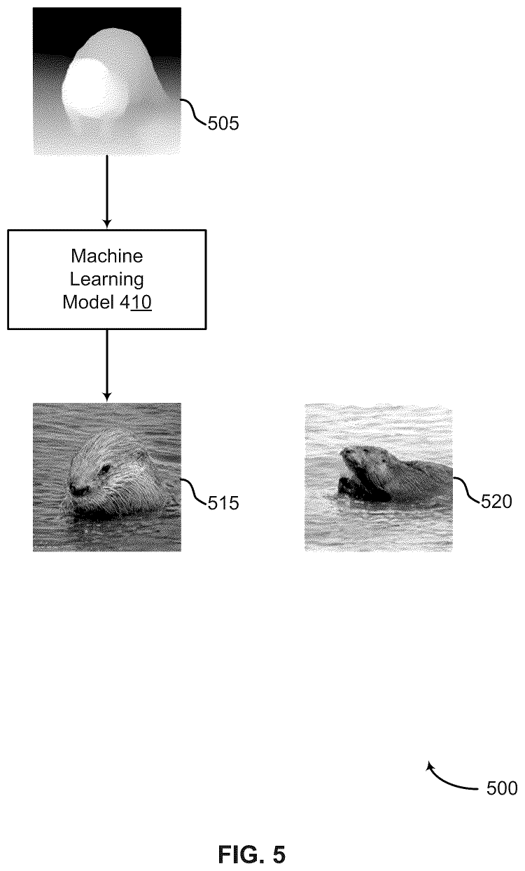

Image generation system 300 is an example of, or includes aspects of, the corresponding element described with reference to FIGS. 4 and 5. Machine learning model 310 is an example of, or includes aspects of, the corresponding element described with reference to FIGS. 4 and 5. Synthetic image 315 is an example of, or includes aspects of, the corresponding element described with reference to FIGS. 4, 5, 8, and 9. Conventional output image 320 is an example of, or includes aspects of, the corresponding element described with reference to FIGS. 4 and 5.

FIG. 4 shows an example of image generation based on a spatial color map 405 according to aspects of the present disclosure. The example shown includes image generation system 400, spatial color map 405, machine learning model 410, synthetic image 415, and conventional output image 420. In some embodiments, image generation system 400 is implemented in a user interface.

Referring to FIG. 4, the image generation system 400 receives a condition map and generates a synthetic image 415 based on the condition map. For example, the condition map includes a spatial color map 405. In some cases, the machine learning model 410 receives the spatial color map 405 and generates a condition sequence of tokens in the discrete latent space. Then, the condition sequence of tokens passes through a set of transformer blocks within a duplicate transformer of the machine learning model 410, where the duplicate transformer generates a condition intermediate output (e.g., a sequence of transformed tokens representing the condition map). In some cases, the machine learning model 410 takes an image mask (e.g., stored in the database) and generates a preliminary sequence of tokens representing the image mask in the discrete latent space. In some cases, the preliminary sequence of tokens passes through a set of transformer blocks within a transformer of the machine learning model 410, where the transformer generates an intermediate output (e.g., a sequence of transformed tokens representing the image mask).

In some embodiments, the condition intermediate output and the intermediate output are combined to generate combined intermediate output at each transformer block of the set of transformer blocks, and the combined intermediate output is used as input to the transformer block to generate the next intermediate output. After the last transformer block, the combined intermediate output is provided to a decoder to generate the synthetic image 415. In some cases, the synthetic image 415 includes the target image structure from the input condition. For example, the synthetic image 415 adheres to the target image structure while maintaining alignment with the class label associated with each image. For example, the spatial color map 405 depicts color patches corresponding to a fox, and the synthetic image 415 depicts the fox that aligns with the color patch.

In some cases, a conventional image generation system (e.g., MaskGIT) is unable to accurately generate a conventional output image 420 depicting the same target image structure from the condition map. In some cases, the conventional system is not fine-tuned with the additional condition input (e.g., the spatial color map 405). In some cases, the conventional system generates an image by predicting masked tokens. However, the conventional system lacks the fine-grained adaptability that the condition map provides. Accordingly, by using the machine learning model 410 (which includes the condition encoder and the duplicate transformer) to generate the condition intermediate output based on the condition map, the machine learning model 410 is able to accurately generate a synthetic image 415 that aligns with the target image structure.

Image generation system 400 is an example of, or includes aspects of, the corresponding element described with reference to FIGS. 3 and 5. Machine learning model 410 is an example of, or includes aspects of, the corresponding element described with reference to FIGS. 3 and 5. Synthetic image 415 is an example of, or includes aspects of, the corresponding element described with reference to FIGS. 3, 5, 8, and 9. Conventional output image 420 is an example of, or includes aspects of, the corresponding element described with reference to FIGS. 3 and 5.

FIG. 5 shows an example of image generation based on a depth map 505 according to aspects of the present disclosure. The example shown includes image generation system 500, depth map 505, machine learning model 510, synthetic image 515, and conventional output image 520. In some embodiments, image generation system 500 is implemented in a user interface.

Referring to FIG. 5, the image generation system 500 receives a condition map and generates a synthetic image 515 based on the condition map. For example, the condition map includes a depth map 505. In some cases, the machine learning model 510 receives the depth map 505 and generates a condition sequence of tokens in the discrete latent space. Then, the condition sequence of tokens passes through a set of transformer blocks within a duplicate transformer of the machine learning model 510, where the duplicate transformer generates a condition intermediate output (e.g., a sequence of transformed tokens representing the condition map). In some cases, the machine learning model 510 takes an image mask (e.g., stored in the database) and generates a preliminary sequence of tokens representing the image mask in the discrete latent space. In some cases, the preliminary sequence of tokens passes through a set of transformer blocks within a transformer of the machine learning model 510, where the transformer generates an intermediate output (e.g., a sequence of transformed tokens representing the image mask).

In some embodiments, the condition intermediate output and the intermediate output are combined to generate combined intermediate output at each transformer block of the set of transformer blocks, and the combined intermediate output is used as input to the transformer block to generate the next intermediate output. After the last transformer block, the combined intermediate output is provided to a decoder to generate the synthetic image 515. In some cases, the synthetic image 515 includes the target image structure from the input condition. For example, the synthetic image 515 adheres to the target image structure while maintaining alignment with the class label associated with each image. For example, the depth map 505 depicts the depth of an otter, and the synthetic image 515 depicts the otter aligning with the depth.

In some cases, a conventional image generation system (e.g., MaskGIT) is unable to accurately generate a conventional output image 520 depicting the same target image structure from the condition map. In some cases, the conventional system is not fine-tuned with the additional condition input (e.g., the depth map 505). In some cases, the conventional system generates an image by predicting masked tokens. However, the conventional system lacks the fine-grained adaptability that the condition map provides. Accordingly, by using the machine learning model 510 (which includes the condition encoder and the duplicate transformer) to generate the condition intermediate output based on the condition map, the machine learning model 510 is able to accurately generate a synthetic image 515 that aligns with the target image structure.

Image generation system 500 is an example of, or includes aspects of, the corresponding element described with reference to FIGS. 3 and 4. Machine learning model 510 is an example of, or includes aspects of, the corresponding element described with reference to FIGS. 3 and 4. Synthetic image 515 is an example of, or includes aspects of, the corresponding element described with reference to FIGS. 3, 4, 8, and 9. Conventional output image 520 is an example of, or includes aspects of, the corresponding element described with reference to FIGS. 3 and 4.

FIG. 6 shows an example of a method 600 for image generation based on a condition map according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the system obtains a condition map including a spatial representation of a target image structure. In some cases, the operations of this step refer to, or may be performed by, a condition encoder as described with reference to FIGS. 7-9. In some cases, for example, the condition map includes an edge map, a spatial color map, or a depth map. For example, the edge map depicts outlines or boundaries within an image or an image to be generated. In some cases, the edge map depicts locations where changes in intensity occur. In some cases, for example, the spatial color map represents color patches corresponding to regions in an image or an image to be generated and indicates the spatial distribution of color. In some cases, for example, the depth map represents the distance of the object from a viewpoint (e.g., a camera), where the object near the viewpoint is represented in a light color (e.g., white) and the object further from the viewpoint is represented in a dark color (e.g., black).

In some cases, target image structure may refer to an outline, boundary, geometric shape, texture pattern, spatial relation (e.g., position and scale of an image element), and/or color transition (e.g., gradient) of an image to be generated. In some cases, the spatial representation of a target image structure refers to the arrangement of image elements that capture the spatial layout and relative positions of image features within a target image. This representation is used to guide the image generation process, ensuring that the model can generate a synthetic image that aligns with the target image structure.

At operation 610, the system encodes, using a condition encoder of an image generation model, the condition map to obtain a condition sequence of tokens representing the target image structure, where a token of the condition sequence of tokens includes an index corresponding to an image patch location. In some cases, the operations of this step refer to, or may be performed by, a condition encoder as described with reference to FIGS. 7-9. In some cases, the condition sequence of tokens is an arrangement (e.g., linear arrangement or matric arrangement) of individual tokens, where each of the tokens corresponds to a specific region, or “patch,” of the condition map. This arrangement retains the spatial layout of the condition map, ensuring that tokens are not simply treated as a sequence but instead reflect the actual arrangement of visual elements across the condition map. Each token in the arrangement is a discrete visual representation, encoding information about local features such as color, texture, or shape within the assigned patch.

In some embodiments, the sequence of tokens is arranged in a matrix form. In some cases, each index in the sequence of tokens corresponds to the location of an image patch within the grid layout of the condition map. This index represents the position of a particular patch in the matrix, enabling the model to map each token back to the original spatial position within the condition map. By maintaining this indexed structure, the image generation model can effectively reconstruct or generate images with accurate spatial relationships, as each index of the tokens aligns with a distinct region of the condition map, preserving the layout and ensuring that neighboring patches maintain the relative positions.

At operation 615, the system generates, using a transformer of the image generation model, an output sequence of tokens based on the condition sequence of tokens and a preliminary sequence of tokens from a discrete codebook, where a token of the output sequence of tokens includes a token from the discrete codebook with the index indicating the image patch location. In some cases, the operations of this step refer to, or may be performed by, a transformer as described with reference to FIGS. 7-9. In some cases, the transformer of the image generation model includes a bidirectional attention mechanism. For example, the transformer is able to process tokens in parallel and capture complex spatial relationships. Using masked visual token modeling (MVTM), the transformer masks and predicts certain tokens during training, learning to generate images by iteratively refining masked areas instead of processing tokens one by one. This bidirectional approach enables faster generation by first predicting high-confidence tokens and refining others, reducing steps, and producing high-quality images that respect spatial structure.

In some cases, the output sequence of tokens may include a sequence of transformed tokens representing the condition map and an input masked token image. In some cases, the preliminary sequence of tokens is an arrangement (e.g., linear arrangement or matric arrangement) of individual tokens, where each of the tokens corresponds to a specific region, or “patch,” of the input masked image. This arrangement retains the spatial layout of the condition map, ensuring that tokens are not simply treated as a sequence but instead reflect the actual arrangement of visual elements across the input masked image. Each token in the arrangement is a discrete visual representation, encoding information about local features such as color, texture, or shape within the assigned patch. In some cases, the output sequence of tokens has the same dimension as the preliminary sequence of tokens or the condition sequence of tokens.

In some cases, a token from the discrete codebook is a compact, quantized representation of a specific visual feature within an image, selected from a fixed set of possible tokens (the codebook). Each entry in the codebook corresponds to a distinct, predefined feature—such as a color, texture, or shape pattern—that encapsulates high-level characteristics of an image patch. During encoding, image patches are matched to the corresponding closest codebook entries, transforming continuous image data into a discrete sequence of tokens. This discrete tokenization enables the image generation model to efficiently handle and generate images while preserving essential visual details.

At operation 620, the system generates, using a decoder the image generation model, a synthetic image based on the output sequence of tokens, where the synthetic image depicts a scene with the target image structure. In some cases, the operations of this step refer to, or may be performed by, a decoder as described with reference to FIGS. 7-9. In some cases, the decoder reconstructs an image (or generates the synthetic image) from discrete tokens by translating each token back into visual features (like color and texture) using embeddings from the discrete codebook. For example, an image element is an image component or image feature that makes up the overall composition of an image, such as an object, entity, subject, shape, color, texture, pattern, background scene, visual attributes, and/or style. For example, the image element may be an animal such as a cat or dog, a person, an object such as a hat or table, a scene such as a beach or mountain top, or a combination thereof. In some cases, for example, an image element may indicate a configuration, a style, a color scheme, a lighting effect, a perspective, a view angle, a texture, or a composition rule of an image. In some cases, a scene may be referred to as a scene.

In some cases, a bidirectional self-attention process is applied to the sequence of tokens (or matrix of tokens), allowing each token to attend to all other tokens in the matrix, regardless of the spatial location. This bidirectional attention enables the model to capture complex relationships in all directions—horizontally, vertically, and diagonally—within the image or the condition map. The bidirectional self-attention process enables the image generation model to iteratively refine the image by considering the context from every part, leading to more coherent and spatially accurate image generation.

Linear attention is an efficient self-attention method that reduces complexity by approximating pairwise token interactions with low-rank approximations. For example, linear attention can be adapted for bidirectional contexts by approximating interactions between tokens in both forward and backward directions without calculating every pairwise relationship. In bidirectional linear attention, each token can attend to all other tokens in the sequence or matrix, both preceding and following it. This is done by factorizing the attention computation so that the model efficiently aggregates information from tokens in all directions, allowing for full context without the heavy computation of traditional bidirectional attention. This approach maintains the benefits of bidirectional processing—such as enhanced context capture—while significantly reducing memory and computational load.

In some embodiments, the subsequent condition sequence of tokens may be referred to as the condition intermediate output with reference to FIGS. 8 and 9. In some cases, an autoregressive generation process is a sequential approach where each output token is generated one at a time, conditioned on all previously generated tokens. In this process, the model starts with an initial token and then predicts the next token based on what has already been generated, repeating this generation process step-by-step until the sequence is complete.

In some cases, a mask token represents a hidden region of an image, signaling to the model that the model should predict the visual content for that area. During training and generation, the model places mask tokens in various locations across the token matrix of an image. The model then iteratively refines the image by predicting and updating these masked tokens based on surrounding, unmasked tokens. This approach enables the model to gradually build a coherent image while learning spatial relationships, as each masked region is reconstructed with context from other parts of the image. In some cases, the mask token may represent a hidden region of a condition map.

### System Architecture

In FIGS. 7-8 and 11, an apparatus and system for image processing include a memory component, a processing device coupled to the memory component, the processing device configured to perform operations comprising: obtaining a condition map comprising a spatial representation of a target image structure, encoding, using a condition encoder of an image generation model, the condition map to obtain a condition sequence of tokens representing the target image structure, where a token of the condition sequence of tokens comprises an index corresponding to an image patch location, generating, using a transformer of the image generation model, an output sequence of tokens based on the condition sequence of tokens and a preliminary sequence of tokens from a discrete codebook, where a token of the output sequence of tokens comprises a token from the discrete codebook with the index indicating the image patch location, and generating, using a decoder the image generation model, a synthetic image based on the output sequence of tokens, where the synthetic image depicts a scene with the target image structure.

In some aspects, the condition encoder comprise a plurality of linear attention blocks. In some aspects, the condition encoder has a same architecture as the transformer of the image generation model. In some aspects, the decoder comprises a VQGAN architecture. Some examples of the apparatus and system further include an encoder configured to generate a sequence of tokens representing an input image.

FIG. 7 shows an example of an image processing apparatus 700 according to aspects of the present disclosure. The example shown includes image processing apparatus 700, processor unit 705, I/O module 710, memory unit 715, and training component 745. In some aspects, memory unit 715 includes image generation model 720, condition encoder 725, transformer 730, encoder 735, and decoder 740.

According to some embodiments of the present disclosure, image processing apparatus 700 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of the inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Image processing apparatus 700 is an example of, or includes aspects of, the corresponding element described with reference to FIG. 1.

Processor unit 705 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 705 is configured to operate a memory array using a memory controller. In other cases, a memory controller is integrated into the processor. In some cases, processor unit 705 is configured to execute computer-readable instructions stored in a memory to perform various functions. In some embodiments, processor unit 705 includes special-purpose components for modem processing, baseband processing, digital signal processing, or transmission processing. Processor unit 705 is an example of, or includes aspects of, the processor described with reference to FIG. 11.

I/O module 710 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 710 includes a user interface. A user interface may enable a user to interact with a device. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 710 is an example of, or includes aspects of, the I/O interface described with reference to FIG. 11.

Examples of memory unit 715 include random access memory (RAM), read-only memory (ROM), or a hard disk. Examples of memory unit 715 include solid-state memory and a hard disk drive. In some examples, memory unit 715 is used to store computer-readable, computer-executable software including instructions that, when executed, cause a processor to perform various functions described herein.

In some cases, memory unit 715 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 715 store information in the form of a logical state.

In one aspect, memory unit 715 includes a machine learning model. In one aspect, the machine learning model includes image generation model 720, condition encoder 725, transformer 730, encoder 735, and decoder 740. In one aspect, the image generation model 720 includes condition encoder 725, transformer 730, encoder 735, and decoder 740. Memory unit 715 is an example, of, or includes aspects of, the memory subsystem described with reference to FIG. 11.

In some cases, the machine learning model is a computational algorithm, model, or system designed to recognize patterns, make predictions, or perform a specific task (for example, image processing) without being explicitly programmed. According to some aspects, machine learning model is implemented as software stored in memory unit 715 and executable by processor unit 705, as firmware, as one or more hardware circuits, or as a combination thereof.

According to some embodiments of the present disclosure, machine learning model includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of the inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, machine learning model includes a computer-implemented CNN. CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, machine learning model includes machine learning parameters. Machine learning parameters, also known as model parameters or weights, are variables that provide behavior and characteristics of machine learning model. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that enables machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, machine learning model includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, machine learning model includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of the elements) is added to the embedded representation (n-dimensional vector) of each word.

In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence) and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, that enables an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

The term “self-attention” refers to a machine learning model in which representations of the input interact with each other to determine attention weights for the input. Self-attention can be distinguished from other attention models because the attention weights are determined at least in part by the input.

According to some aspects, image generation model 720 is implemented as software stored in memory unit 715 and executable by processor unit 705, as firmware, as one or more hardware circuits, or as a combination thereof. According to some aspects, image generation model 720 performs a linear attention process on the condition sequence of tokens to obtain a subsequent condition sequence of tokens, where the output sequence of tokens is generated based on the subsequent condition sequence of tokens. In some examples, image generation model 720 performs a linear attention process on the preliminary sequence of tokens. In some aspects, the linear attention process includes an autoregressive generation process. In some aspects, the linear attention process includes a bidirectional generation process. In some aspects, each of the preliminary sequence of tokens includes a mask token.

In some examples, image generation model 720 combines the condition sequence of tokens and the preliminary sequence of tokens to obtain a combined sequence of tokens, where the output sequence of tokens is based on the combined sequence of tokens. In some aspects, image generation model 720 generates a synthetic image based on the output sequence of tokens, where the synthetic image depicts a scene with the target image structure.

According to some aspects, condition encoder 725 is implemented as software stored in memory unit 715 and executable by processor unit 705, as firmware, as one or more hardware circuits, or as a combination thereof. According to some aspects, condition encoder 725 obtains a condition map including a spatial representation of a target image structure. In some examples, condition encoder 725 encodes the condition map to obtain a condition sequence of tokens representing the target image structure, where a token of the condition sequence of tokens includes an index corresponding to an image patch location. In some aspects, the condition map includes an edge map, a spatial color map, or a depth map.

According to some aspects, condition encoder 725 obtains a condition map including a spatial representation of a target image structure. In some examples, condition encoder 725 encodes the condition map to obtain a condition sequence of tokens representing the target image structure, where a token of the condition sequence of tokens comprises an index corresponding to an image patch location. In some aspects, the condition encoder 725 include a set of linear attention blocks. In some aspects, the condition encoder 725 has a same architecture as the transformer 730 of the image generation model 720. In some embodiments, the condition encoder 725 includes the transformer 730.

According to some aspects, condition encoder 725 encodes, using a first linear attention process, a condition map to obtain a condition sequence of tokens representing a target image structure. Condition encoder 725 is an example of, or includes aspects of, the corresponding element described with reference to FIGS. 7 and 9.

According to some aspects, transformer 730 is implemented as software stored in memory unit 715 and executable by processor unit 705, as firmware, as one or more hardware circuits, or as a combination thereof. According to some aspects, transformer 730 generates an output sequence of tokens based on the condition sequence of tokens and a preliminary sequence of tokens from a discrete codebook, where a token of the output sequence of tokens includes a token from the discrete codebook with the index indicating the image patch location.

According to some aspects, transformer 730 generates an output sequence of tokens based on the condition sequence of tokens and a preliminary sequence of tokens from a discrete codebook, where a token of the output sequence of tokens comprises a token from the discrete codebook with the index indicating the image patch location. According to some aspects, transformer 730 generates an output sequence of tokens based on the condition sequence of tokens and a preliminary sequence of tokens. Transformer 730 is an example of, or includes aspects of, the corresponding element described with reference to FIGS. 7 and 9.

According to some aspects, encoder 735 is configured to generate a sequence of tokens representing an input image. In some cases, the encoder 735 includes a VQGAN architecture. Encoder 735 is an example of, or includes aspects of, the image encoder described with reference to FIG. 7.

According to some aspects, decoder 740 is implemented as software stored in memory unit 715 and executable by processor unit 705, as firmware, as one or more hardware circuits, or as a combination thereof. According to some aspects, decoder 740 generates a synthetic image based on the output sequence of tokens, where the synthetic image depicts a scene with the target image structure.

According to some aspects, decoder 740 generates a synthetic image based on the output sequence of tokens, where the synthetic image depicts a scene with the target image structure. In some aspects, the decoder 740 includes a VQGAN architecture. Decoder 740 is an example of, or includes aspects of, the corresponding element described with reference to FIGS. 7 and 9.

According to some aspects, image processing apparatus 700 includes a training component 745. The training component 745 is implemented as software stored in memory unit 715 and executable by processor unit 705, as firmware, as one or more hardware circuits, or as a combination thereof. According to some embodiments, the training component 745 is implemented as software stored in a memory unit and executable by a processor in the processor unit of a separate computing device, as firmware in the separate computing device, as one or more hardware circuits of the separate computing device, or as a combination thereof. In some examples, the training component 745 is part of another apparatus other than image processing apparatus 700 and communicates with the image processing apparatus 700. In some examples, training component 745 is part of image processing apparatus 700.

In some aspects, the training component 745 trains the image generation model 720 using a training set including a masked image and a training condition map including a spatial representation of an image structure of the masked image.

FIG. 8 shows an example of a machine learning model according to aspects of the present disclosure. The example shown includes machine learning system 800, condition map 805, condition encoder 810, condition embedding 815, duplicate transformer 820, condition intermediate output 835, input 840, image encoder 845, image embedding 850, transformer 855, intermediate output 870, combined output 875, decoder 880, and synthetic image 885. In one aspect, duplicate transformer 820 includes duplicate attention layer 825 and duplicate MLP 830. In one aspect, transformer 855 includes attention layer 860 and MLP 865.

Referring to FIG. 8, the machine learning system 800 receives the condition map 805 and generates the synthetic image 885. For example, the condition encoder 810 receives the condition map 805 and generates condition embedding 815. In some cases, the condition map 805 is an edge map depicting the boundaries of an image element (e.g., a dog). In some cases, the condition embedding 815 is a sequence of discrete visual tokens (or a condition sequence of tokens) in a discrete latent space. In some embodiments, the condition encoder 810 may be a VQGAN image encoder trained to tokenize an input image to generate a sequence of discrete tokens. In some embodiments, the condition encoder 810 may be an encoder trained to generate a sequence of discrete tokens based on a condition map.

In some embodiments, the condition embedding 815 is provided to the duplicate transformer 820 to generate a condition intermediate output 835. For example, the condition embedding 815 is passed through a first transformer block including a duplicate attention layer 825 and a duplicate MLP 830 to generate a condition intermediate output 835. In some cases, the condition intermediate output 835 includes a condition sequence of tokens that is transformed and represents the condition map 805. In some cases, the duplicate transformer 820 has the same architecture as the transformer 855. In some aspects, the condition encoder includes the condition encoder 810 and the duplicate transformer 820.

In some embodiments, an input 840 is provided to an image encoder 845 to generate image embedding 850. For example, the input 840 includes a mask image, a mask token image, or a token image. In some cases, the image embedding 850 is a sequence of discrete visual tokens (or a preliminary sequence of tokens) in a discrete latent space. In some embodiments, the image encoder 845 is a VQGAN image encoder configured to tokenize an input image to generate a sequence of discrete tokens.

According to some embodiments, the image embedding 850 is provided to the transformer 855 to generate the intermediate output 870. For example, the image embedding 850 is passed through a first transformer block of the transformer 855 including an attention layer 860 and an MLP 865 to generate an intermediate output 870. In some cases, the intermediate output 870 includes a sequence of tokens that is transformed and represents the input 840.

In some aspects, attention layer 860 or a self-attention layer includes an attention mechanism that enables each token in a sequence or matrix to dynamically focus on other tokens based on the relevance of the tokens, capturing relationships across the input. Each token computes attention scores with other tokens, determining how much the token “attends to” or considers each one. This process results in weighted representations, where each token becomes contextually enriched by incorporating information from relevant parts of the input. In some aspects, the self-attention layer captures spatial dependencies across the entire image (e.g., input 840 or condition map 805), enabling the model to understand and generate coherent visual features based on the interactions between tokens.

In some cases, the MLP 865 (multilayer perceptron) includes a neural network component including fully connected layers. MLP 865 is used within the transformer to process and transform information between tokens. An MLP 865 includes multiple linear layers with activation functions (like ReLU) applied in between, enabling the MLP 865 to learn complex transformations and improve the ability of the transformer 855 to capture relationships and patterns in the data. In some cases, MLP 865 is used after the self-attention layers (e.g., attention layer 860) within each transformer block to refine the representation of each token by applying non-linear transformations.

In some embodiments, the condition intermediate output 835 and intermediate output 870 are combined to generate combined output 875. In some cases, the combined output 875 is a sequence of discrete visual tokens in a discrete latent space that represents the condition map 805 and the input 840. In some embodiments, the decoder 880 receives the combined output 875 and generates the synthetic image 885 based on the combined output 875.

According to some embodiments, the condition intermediate output 835 is passed through a second transformer block of the duplicate transformer 820 including the duplicate attention layer 825 and the duplicate MLP 830 to generate a second condition intermediate output. In some embodiments, the intermediate output 870 is passed through a second transformer block of the transformer 855 including attention layer 860 and MLP 865 to generate a second intermediate output. In some embodiments, the second condition intermediate output and the second intermediate output are combined to generate the combined output 875. In some embodiments, the decoder 880 decodes the combined output 875 to generate the synthetic image 885.

In some embodiments, the duplicate transformer 820 includes fewer transformer blocks than the transformer blocks in the transformer 855. In some embodiments, the duplicate transformer 820 includes the same number of transformer blocks as the transformer blocks in the transformer 855. In some embodiments, the number of transformer blocks of the duplicate transformer is half of the number of transformer blocks in transformer 855. In some cases, the duplicate transformer 820 may be referred to as a ControlNet.

According to some embodiments, the ControlNet (e.g., the duplicate transformer 820) is combined with a transformer-based image generation model enabling to receive additional control input, whereas conventional ControlNet is combined with a diffusion-based image generation model. To combine the ControlNet with the transformer network, the first transformer block of transformer 855 is duplicated with pre-trained weights. In some embodiments, the transformer 855 includes attention, feed-forward, and layer normalization layers. In some cases, the input to the first duplicated block is the encoded condition (e.g., the condition embedding 815) that was passed through a trainable zero-convolution, and the encoded masked input image (e.g., the image embedding) that is added element-wise with the encoded condition. The output of the duplicate transformer block (e.g., the duplicate transformer 820) is forwarded to a second trainable zero-convolution layer. A difference between the conventional ControlNet architecture with diffusion-based models and the machine learning system 800 is that the machine learning system 800 has no additional structure such as down-sampling blocks, encoder-decoder architecture, or a U-Net architecture. Accordingly, the duplicate block construction process can be repeated for the remaining transformer blocks in transformer 855.

In some embodiments, the duplicate transformer 820 is connected to the transformer 855. Compared to the ControlNet architecture with diffusion-based models, the construction of the machine learning system 800 is different than those in ControlNet architecture with diffusion-based models. For example, the machine learning system 800 has a transformer-based architecture and the conventional ControlNet system has a diffusion-based architecture (e.g., a U-Net architecture or diffusion transformer architecture). In addition, the machine learning system 800 operates in a discrete latent space, whereas the conventional system operates in a continuous latent space. In some cases, the processing speed in a discrete latent space may be faster than the processing speed in a continuous latent space.

In some cases, the conventional system includes a U-Net architecture. For example, the network features are arranged in an encoder-decoder structure with residual connections between the corresponding encoder and decoder layers with the same resolution. In some cases, the U-net architecture includes one convolutional middle layer (with the lowest dimensionality/resolution) that represents the information bottleneck with no corresponding layers. In some cases, the encoder layers down-samples features to lower dimensionality, and the decoder layers upsamples the down-sampled features to higher dimensionality to the original dimension of the input features. However, this encoder-decoder architecture may reduce the inference speed of image generation.

The machine learning system 800 includes a transformer architecture and does not have a U-Net structure. Accordingly, machine learning system 800 and conventional system (e.g., ControlNet with diffusion model) have different architectural designs. For example, each output of the duplicate transformer 820 is combined with each output of the transformer 855. In some cases, a conventional system has a zero convolution operation with a 2-dimensional convention with a 1×1 kernel. However, since machine learning system 800 is transformer-based, the zero-convolution operation is modified to a 1-dimensional convolution operation with a kernel size of 1×1 and a stride of 1. In some cases, the convolution operation can be further simplified to a zero-initialized linear layer since the operation is equivalent to the convolutional layer with the aforementioned configuration and parameters.

In some embodiments, the condition encoder 810 includes a ViT trained to encode the condition map 805 to generate condition embedding 815 (e.g., the ViT patch embedding). In some cases, the ViT patch embedding transforms an image into a sequence of equally sized and non-overlapping patches and embeds the patches together with positional encodings via a linear projection. In some cases, these embeddings have the same dimensionality as the intermediate output 870 generated by the transformer 855. In some cases, these embeddings are combined element-wise with the intermediate output 870. In some cases, the ViT patch embeddings are trained for the additional input conditions (e.g., condition map 805) jointly with the duplicate transformer 820 during fine-tuning of the machine learning system 800.

In some embodiments, the condition encoder 810 includes a second pre-trained VQGAN encoder different from the VQGAN encoder of the image encoder 845. For example, the second pre-trained VQGAN encoder is trained jointly with the duplicate transformer 820 to generate discrete latent representations (e.g., condition embedding 815). In some embodiments, the condition encoder 810 may include a pre-trained CLIP encoder, and encodings of the pre-trained CLIP encoder are linearly projected to the target dimensionality of the intermediate output 870 of the transformer 855.

According to some embodiments, each of the preliminary sequence of tokens comprises a mask token. In some cases, each of the preliminary sequence of tokens comprises at least one mask token. For example, during the iterative decoding process, the machine learning system 800 begins with a fully masked image (e.g., the input 840), where each token is masked out. In each iteration, the machine learning system 800 progressively predicts and fills in more tokens based on the current best estimates, and keeps the highest-confidence predictions in each step. As iterations continue, more and more tokens are filled in, gradually revealing the structure and content of the image. The model refines the predictions iteratively, using context from previously predicted tokens and attending to unfilled regions. This parallel, iterative decoding process enables the machine learning system 800 to generate high-quality images efficiently, as the system fills in all parts of the image over a few steps, rather than using a slower, sequential approach.

Machine learning system 800 is an example of, or includes aspects of, the corresponding element described with reference to FIG. 9. Condition map 805 is an example of, or includes aspects of, the corresponding element described with reference to FIG. 9. Condition encoder 810 is an example of, or includes aspects of, the corresponding element described with reference to FIGS. 7 and 9. Duplicate transformer 820 is an example of, or includes aspects of, the corresponding element described with reference to FIG. 9.

Condition intermediate output 835 is an example of, or includes aspects of, the corresponding element described with reference to FIG. 9. Input 840 is an example of, or includes aspects of, the corresponding element described with reference to FIG. 9. Image encoder 845 is an example of, or includes aspects of, the corresponding element described with reference to FIG. 9. Transformer 855 is an example of, or includes aspects of, the corresponding element described with reference to FIGS. 7 and 9.

Intermediate output 870 is an example of, or includes aspects of, the corresponding element described with reference to FIG. 9. Combined output 875 is an example of, or includes aspects of, the corresponding element described with reference to FIG. 9. Decoder 880 is an example of, or includes aspects of, the corresponding element described with reference to FIGS. 7 and 9. Synthetic image 885 is an example of, or includes aspects of, the corresponding element described with reference to FIGS. 3-5, and 9.

### Data Flow in Image Generation System

FIG. 9 shows an example of data flow in a machine learning model according to aspects of the present disclosure. The example shown includes machine learning system 900, condition map 905, condition encoder 910, condition sequence of tokens 915, duplicate transformer 920, condition intermediate output 925, input 930, image encoder 935, preliminary sequence of tokens 940, transformer 945, intermediate output 950, combined output 955, decoder 960, and synthetic image 965.

Referring to FIG. 9, the machine learning system 900 receives the condition map 905 and generates a synthetic image 965. For example, the condition encoder 910 receives the condition map 905 and generates the condition sequence of tokens 915. The condition sequence of tokens 915 is provided to the duplicate transformer 920 to generate condition intermediate output 925. In some cases, one or more condition intermediate outputs are generated based on the number of transformer blocks of the duplicate transformer 920.

In some embodiments, the image encoder 935 receives the input 930 and generates a preliminary sequence of tokens 940. The preliminary sequence of tokens 940 is provided to the transformer 945 to generate intermediate output 950. In some cases, one or more intermediate outputs are generated based on the number of transformer blocks of the transformer 945. In some embodiments, the condition intermediate output 925 is added to the intermediate output 950 to generate combined output 955. In some embodiments, each of the condition intermediate outputs at each transformer block of the duplicate transformer 920 is added to each of the intermediate outputs at each corresponding transformer block of the transformer 945 to generate the combined output 955. In some embodiments, the decoder 960 receives the combined output 955 to generate the synthetic image 965.

Machine learning system 900 is an example of, or includes aspects of, the corresponding element described with reference to FIG. 8. Condition map 905 is an example of, or includes aspects of, the corresponding element described with reference to FIG. 8. Condition encoder 910 is an example of, or includes aspects of, the corresponding element described with reference to FIGS. 7 and 8. Duplicate transformer 920 is an example of, or includes aspects of, the corresponding element described with reference to FIG. 8.

Condition intermediate output 925 is an example of, or includes aspects of, the corresponding element described with reference to FIG. 8. Input 930 is an example of, or includes aspects of, the corresponding element described with reference to FIG. 8. Image encoder 935 is an example of, or includes aspects of, the corresponding element described with reference to FIG. 8. Transformer 945 is an example of, or includes aspects of, the corresponding element described with reference to FIGS. 7 and 8.

Intermediate output 950 is an example of, or includes aspects of, the corresponding element described with reference to FIG. 8. Combined output 955 is an example of, or includes aspects of, the corresponding element described with reference to FIG. 8. Decoder 960 is an example of, or includes aspects of, the corresponding element described with reference to FIGS. 7 and 8. Synthetic image 965 is an example of, or includes aspects of, the corresponding element described with reference to FIGS. 3-5, and 8.

### Training and Evaluation

In FIG. 10, a method, apparatus, non-transitory computer readable medium, and system for image processing include obtaining a training set including a training image and a condition map, where the training image depicts an image element and the condition map depicts represents an image feature of the image element, generating a synthetic image based on the training image and the condition map, and training, using the training set and the synthetic image, a first image generation model to generate a first intermediate output based on the training image and the condition map.

Examples of a method, apparatus, non-transitory computer readable medium, and system for image processing further include generating a masked training image based on the training image and a mask, where the first image generation model is trained based on the masked training image. Examples of a method, apparatus, non-transitory computer readable medium, and system for image processing further include generating, using a condition encoder, a condition embedding based on the condition map, where the first intermediate output is generated based on the condition embedding.

Examples of a method, apparatus, non-transitory computer readable medium, and system for image processing further include the first image generation model and the condition encoder are trained jointly. In some aspects, the image generation model is trained using a training set including a masked image and a training condition map comprising a spatial representation of an image structure of the masked image.

FIG. 10 shows an example of a flow diagram depicting an algorithm as a step-by-step procedure in an example implementation of operations performable for training a machine learning model according to aspects of the present disclosure. In some embodiments, the procedure 1000 describes an operation of the training component described for configuring the image generation model 720 as described with reference to FIG. 7. The procedure 1000 provides one or more examples of generating training data, use of the training data to train a machine-learning model, and use of the trained machine-learning model to perform a task.

To begin in this example, a machine-learning system collects training data (block 1002) to be used as a basis to train a machine-learning model, which defines what is being modeled. The training data is collectible by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1004) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 1006). Initialization of the machine-learning model includes selecting a model architecture (block 1008) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, U-Net architecture, etc.

A loss function is also selected (block 1010). The loss function is utilized to measure a difference between an output of the machine-learning model (e.g., the model predictions) and target values (e.g., as expressed by the training data) to be used to train the machine-learning model. Additionally, an optimization algorithm is selected (block 1012) to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1016) examples of which include initializing weights and biases of nodes to increase efficiency in training and computational resources consumption as part of training. Hyperparameters are also set (block 1014) that are used to control training of the machine learning model, examples of which include regularization parameters, model parameters (e.g., a number of layers in a neural network), learning rate, batch sizes selected from the training data, and so on. The hyperparameters are set using a variety of techniques, including the use of a randomization technique, through the use of heuristics learned from other training scenarios, and so forth.

The machine-learning model is then trained using the training data (block 1018) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through the use of the selected loss function and backpropagation to optimize the performance of the machine-learning model to perform an associated task.

As part of training the machine-learning model, a determination is made as to whether a stopping criterion is met (decision block 1020), which is used to validate the machine-learning model. The stopping criterion is usable to reduce the overfitting of the machine-learning model, reduce computational resource consumption, and promote the ability of the machine-learning model to address unseen data not included as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1020), procedure 1000 continues the training of the machine-learning model using the training data (block 1018) in this example.

If the stopping criterion is met (“yes” from decision block 1020), the trained machine-learning model is then utilized to generate an output based on subsequent data (block 1022). The trained machine-learning model, for instance, is trained to perform a task as described above and therefore once trained is configured to perform that task based on subsequent data received as an input and processed by the machine-learning model.

### Training Loss

According to some embodiments, the machine learning system described with reference to FIG. 8 is trained using the following training loss:

$${ℒ}_{mask} = - {\sum }_{i = 1 , {m}_{i} = 1}^{N} log p ( {y}_{i} \vert {Y}_{M} , {F}_{C} ) \qquad ( 1 )$$

where [symbol] ₘₐₛₖ represents the masking loss used to train the machine learning model. In some cases, the model is trained to minimize masking loss to accurately predict the masked tokens. [symbol] represents the expectation over the training dataset, N represents the total number of tokens in the tokenized image.

$${\sum }_{i = 1 , {m}_{i} = 1}^{N} :$$

represents the summation of all tokens in the image that are masked. p(yᵢ|Y_{M}, F_{C}) is the conditional probability of the target token yᵢ given the token matrix Y_{M} and conditioning factors F_{C}.

### Computer Device

FIG. 11 shows an example of a computing device 1100 according to aspects of the present disclosure. The example shown includes computing device 1100, processor 1105, memory subsystem 1110, communication interface 1115, I/O interface 1120, user interface component 1125, and channel 1130.

In some embodiments, computing device 1100 is an example of, or includes aspects of, the image processing apparatus described with reference to FIGS. 1 and 7. In some embodiments, computing device 1100 includes processor 1105 that can execute instructions stored in memory subsystem 1110 to obtain a condition map comprising a spatial representation of a target image structure, encode the condition map to obtain a condition sequence of tokens representing the target image structure, generate an output sequence of tokens based on the condition sequence of tokens and a preliminary sequence of tokens from a discrete codebook, and generate a synthetic image based on the output sequence of tokens.

According to some embodiments, processor 1105 includes one or more processors. In some cases, processor 1105 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 1105 is configured to operate a memory array using a memory controller. In other cases, a memory controller is integrated into processor 1105. In some cases, processor 1105 is configured to execute computer-readable instructions stored in a memory to perform various functions. In some embodiments, processor 1105 includes special-purpose components for modem processing, baseband processing, digital signal processing, or transmission processing. Processor 1105 is an example of, or includes aspects of, the processor unit described with reference to FIG. 7.

According to some embodiments, memory subsystem 1110 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1110 is an example of, or includes aspects of, the memory unit described with reference to FIG. 7.

According to some embodiments, communication interface 1115 operates at a boundary between communicating entities (such as computing device 1100, one or more user devices, a cloud, and one or more databases) and channel 1130 and can record and process communications. In some cases, communication interface 1115 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1115.

According to some embodiments, I/O interface 1120 is controlled by an I/O controller to manage input and output signals for computing device 1100. In some cases, I/O interface 1120 manages peripherals not integrated into computing device 1100. In some cases, I/O interface 1120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1120 or hardware components controlled by the I/O controller. I/O interface 1120 is an example of, or includes aspects of, the I/O module described with reference to FIG. 7.

According to some embodiments, user interface component 1125 enables a user to interact with computing device 1100. In some cases, user interface component 1125 includes an audio device, such as an external speaker system, an external display device such as a display screen, an input device (e.g., a remote-control device interfaced with a user interface directly or through the I/O controller), or a combination thereof.

The performance of apparatus, systems, and methods of the present disclosure have been evaluated, and results indicate embodiments of the present disclosure have obtained increased performance over conventional technology (e.g., conventional image generation models). Example experiments demonstrate that the image processing apparatus based on the present disclosure outperforms conventional image generation models. Details on the example use cases based on embodiments of the present disclosure are described with reference to FIGS. 3-5.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a condition map comprising a spatial representation of a target image structure;
encoding, using a condition encoder of an image generation model, the condition map to obtain a condition sequence of tokens representing the target image structure;
generating, using a transformer of the image generation model, an output sequence of tokens based on the condition sequence of tokens and a preliminary sequence of tokens from a discrete codebook; and
generating, using a decoder the image generation model, a synthetic image based on the output sequence of tokens, wherein the synthetic image depicts a scene with the target image structure.

2. The method of claim 1, further comprising:
performing a linear attention process on the condition sequence of tokens to obtain a subsequent condition sequence of tokens, wherein the output sequence of tokens is generated based on the subsequent condition sequence of tokens.

3. The method of claim 1, wherein generating the output sequence of tokens comprises:
performing a linear attention process on the preliminary sequence of tokens.

4. The method of claim 3, wherein:
the linear attention process comprises a bidirectional generation process.

5. The method of claim 1, wherein:
a token of the condition sequence of tokens comprises an index corresponding to an image patch location and a token of the output sequence of tokens comprises a token from the discrete codebook with the index indicating the image patch location.

6. The method of claim 1, wherein:
each of the preliminary sequence of tokens comprises a mask token.

7. The method of claim 1, wherein generating the output sequence of tokens comprises:
combining the condition sequence of tokens and the preliminary sequence of tokens to obtain a combined sequence of tokens, wherein the output sequence of tokens is based on the combined sequence of tokens.

8. The method of claim 1, wherein:
the condition map comprises an edge map, a spatial color map, or a depth map.

9. The method of claim 1, wherein:
the image generation model is trained using a training set including a masked image and a training condition map comprising a spatial representation of an image structure of the masked image.

10. A non-transitory computer readable medium storing code for image processing, the code comprising instructions that, when executed by at least one processor, cause the at least one processor to perform operations comprising:
encoding, using a first linear attention process, a condition map to obtain a condition sequence of tokens representing a target image structure;
generating, using a second linear attention process, an output sequence of tokens based on the condition sequence of tokens and a preliminary sequence of tokens; and
generating, using an image generation model, a synthetic image based on the output sequence of tokens, wherein the synthetic image depicts a scene with the target image structure.

11. The non-transitory computer readable medium of claim 10, wherein:
the first linear attention process comprises an autoregressive generation process.

12. The non-transitory computer readable medium of claim 10, wherein:
the first linear attention process comprises a bidirectional generation process.

13. The non-transitory computer readable medium of claim 10, wherein:
each of the preliminary sequence of tokens comprises a mask token.

14. The non-transitory computer readable medium of claim 10, wherein generating the output sequence of tokens comprises:
combining the condition sequence of tokens and the preliminary sequence of tokens to obtain a combined sequence of tokens, wherein the output sequence of tokens is based on the combined sequence of tokens.

15. The non-transitory computer readable medium of claim 10, wherein:
the condition map comprises an edge map, a spatial color map, or a depth map.

16. A system comprising:
a memory component; and
a processing device coupled to the memory component, the processing device configured to perform operations comprising:
obtaining a condition map comprising a spatial representation of a target image structure;
encoding, using a condition encoder of an image generation model, the condition map to obtain a condition sequence of tokens representing the target image structure, wherein a token of the condition sequence of tokens comprises an index corresponding to an image patch location;
generating, using a transformer of the image generation model, an output sequence of tokens based on the condition sequence of tokens and a preliminary sequence of tokens from a discrete codebook, wherein a token of the output sequence of tokens comprises a token from the discrete codebook with the index indicating the image patch location; and
generating, using a decoder the image generation model, a synthetic image based on the output sequence of tokens, wherein the synthetic image depicts a scene with the target image structure.

17. The system of claim 16, wherein:
the condition encoder comprises a plurality of linear attention blocks.

18. The system of claim 16, wherein:
the condition encoder has a same architecture as the transformer of the image generation model.

19. The system of claim 16, wherein:
the decoder comprises a VQGAN architecture.

20. The system of claim 16, further comprising:
an encoder configured to generate a sequence of tokens representing an input image.
